(19) United States
(12) Patent Application Publication
(10) Pub. No.: US 2022/0347916 A1
(43) Pub. Date: Nov. 3, 2022

(54) 3D PRINTING ONTO EXISTING STRUCTURES

(71) Applicant: Snap Inc., Santa Monica, CA (US)

(72) Inventor: Simon Nielsen, Beverly Hills, CA (US)

(21) Appl. No.: 17/727,950

(22) Filed: Apr. 25, 2022

Related U.S. Application Data
(60) Provisional application No. 63/182,061, filed on Apr. 30, 2021.

(51) Int. Cl. B29C 64/118; B33Y 10/00; B33Y 80/00; B28B 1/00; B22F 10/18

(52) U.S. Cl. CPC B29C 64/118; B33Y 10/00; B33Y 80/00; B28B 1/001; B22F 10/18

(57) ABSTRACT

A 3D item formed on a base having a cavity or void to form an anchor. An extruded filament of a heated material is first deposited into the cavity at a high temperature and high flow rate such that the material flows easier and fills the cavity and forms the anchor. After the cavity is filled such that the anchor is formed, the extrusion of the filament continues at a lower temperature and at a lower flow rate to form the 3D item upon the anchor. The extruded filament in the cavity and the 3D item are a unitary item.

### CROSS-REFERENCE TO RELATED APPLICATIONS

This application claims priority to U.S. Provisional Application No. 63/182,061 filed on Apr. 30, 2021, the contents of which are incorporated fully herein by reference.

### TECHNICAL FIELD

The present disclosure generally relates to three-dimensional (3D) printing.

### BACKGROUND

3D printing is used to make 3D items using a fused deposition modeling (FDM). Other terms for 3D printing include fused filament fabrication (FFF) and filament 3D printing (FDP).

### BRIEF DESCRIPTION OF THE DRAWINGS

In the drawings, which are not necessarily drawn to scale, like numerals may describe similar components in different views. Like numerals having different letter suffixes may represent different instances of similar components. Some examples are illustrated by way of example, and not limitation, in the figures of the accompanying drawings in which:

FIG. 1 illustrates a 3D printer, and a base having a cavity;

FIG. 2 illustrates the extruded filament dispensed by the 3D printer into the cavity to completely fill the cavity and form an anchor within the cavity;

FIG. 3 illustrates a graph of the printer head temperature and the speed of extruding a filament;

FIG. 4 illustrates a top perspective view of the base;

FIG. 5 illustrates a method of forming the anchor in the base and a 3D item upon anchor;

FIG. 6 is a diagrammatic representation of a machine in the form of a computer system within which a set of instructions may be executed for causing the machine to perform any one or more of the methodologies discussed herein, in accordance with some examples; and

FIG. 7 is block diagram showing a software architecture within which the present disclosure may be implemented, in accordance with examples.

### DETAILED DESCRIPTION

This disclosure provides 3D manufacturing of a 3D item on a base having a cavity or void to form an anchor. An extruded filament of a heated material is first deposited into the cavity at a high temperature and high flow rate such that the material flows easier and fills the cavity and forms the anchor. After the cavity is filled such that the anchor is formed, the extrusion of the filament continues at a lower temperature and at a lower flow rate to form the 3D item upon the anchor. The extruded filament in the cavity and the 3D item are a unitary item.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

The description that follows includes systems, methods, techniques, instruction sequences, and computing machine program products illustrative of examples of the disclosure. In the following description, for the purposes of explanation, numerous specific details are set forth in order to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

The terms and expressions used herein are understood to have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

Reference now is made in detail to the examples illustrated in the accompanying drawings and discussed below.

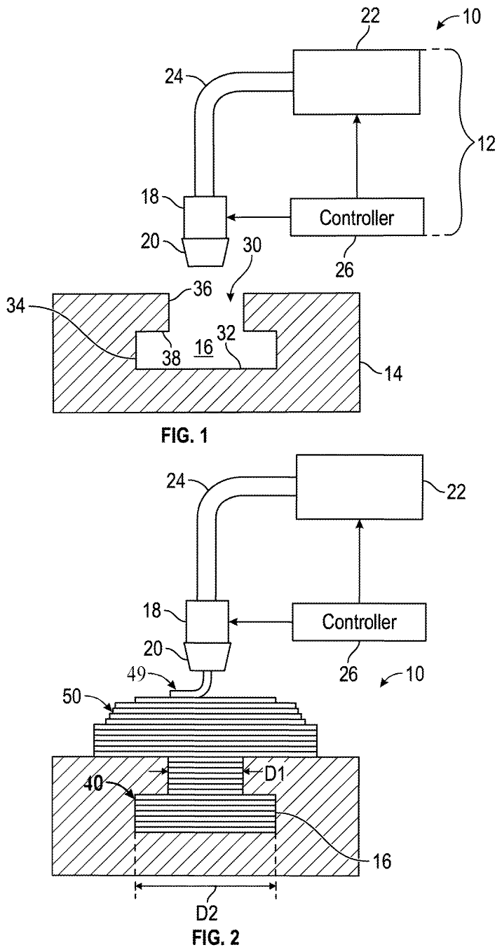

Referring to FIG. 1, there is illustrated a system 10 including a 3D printer generally shown at 12, and a base 14 having a cavity 16. The 3D printer 12 includes a printer head 18, a printer nozzle 20 coupled to the printer head 18, a source of extrudable material 22, and a conduit 24 configured to feed the extrudable material 22 to the printer head 18. The cavity 16 is formed in the base 14 to have an opening 30, a bottom 32, sidewalls 34, and a shoulder 36 encompassing the opening 30 and forming a flange 38. A controller 26 controls the dispensing of the extrudable material 22 to the printer head 18, and also controls the heat of the printer head 18 to generate an extruded filament 49 that is emitted by the printer nozzle 20 into the cavity 16, as shown in FIG. 2. The extrudable material 22 can be formed of many materials, such as a thermoplastic, a ceramic, and a metal. The extrudable material 22 may be stored as a coil or roller that feeds to the printer head 18, as controlled by the controller 26 including a processor.

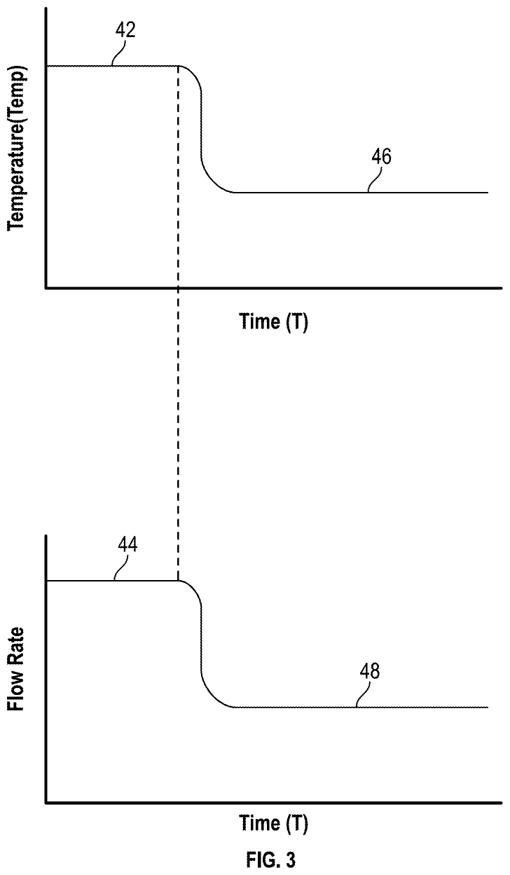

Referring to FIG. 2, there is illustrated the extruded filament 49 dispensed by the 3D printer 12 into the cavity 16 to completely fill the cavity 16 and form an anchor 40 within the cavity 16. The controller 26 causes the printer head 18 to heat at a high temperature, such as 300 degrees Celsius, as shown at 42 in FIG. 3, and at a high flow rate, such as 2 cm/s, as shown at 44 in FIG. 3 such that the extruded filament 49 flows easily and fills up the entire cavity 16, forming anchor 40 as shown in FIG. 2. After the cavity 16 is filled, the controller 26 causes the printer head 18 to reduce the heat of the printer head to a nominal temperature, such as 150 degrees Celsius, as shown at 46 in FIG. 3, where the 3D printer 12 continues to extrude the filament 49 without interruption, at a slower flow rate, such as 1 cm/s, as shown at 48 to form the 3D item 50. In an example, the printer head high temperature when filling the cavity may be 2× the temperature when forming the 3D item 50, and the filament high flow rate may be 2× the slower flow rate as shown in FIG. 3 when forming the 3D item 50. During the 3D process, the base 14 may be heated, such as at 200 degrees Celsius, as controlled by controller 26, to control the formation of the anchor 40. The anchor 40 is allowed to cool to form a solid such that the 3D item 50 cannot be removed from base 14.

As shown in FIG. 2, the base 14 including the flange 38 encapsulates the extruded material in cavity 16 forming the anchor 40 to retain the anchor 40 such that the 3D item 50 cannot be removed from base 14. As seen, the diameter D1 of opening 30 is smaller than a diameter D2 of the cavity 16 formed by sidewalls 34.

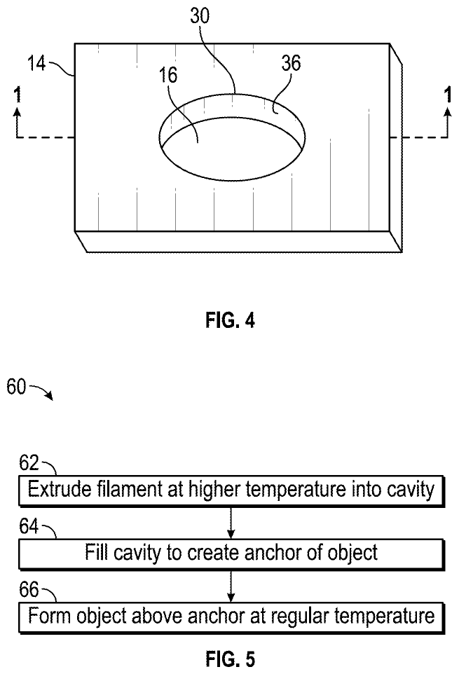

FIG. 4 illustrates a top perspective view of the base 14, showing the opening 30 leading to the cavity 16, where FIG. 1 is taken along line 1-1 in FIG. 4. The flange 38 is also shown that retains the anchor 40 in the base 14. The base 14 can be formed of many materials, such as plastic, ceramic, and metal, and limitation to the material of the base 14 is not to be inferred.

Referring to FIG. 5, there is shown a method 60 for generating the anchor 40 and the 3D item 50. The 3D item 50 can be selected to take many forms as desired, such as toys, molds etc.

At block 62, the controller 26 causes the filament 49 to be extruded from the nozzle 20 into the cavity 16, as shown in FIG. 2. The controller 26 controls the heat of printer head 18 as shown at 42 in FIG. 3 to have a high temperature, such as 200 degrees Celsius, and also controls the flow rate of the filament 49 to have a high flow rate, such as shown at 44.

At block 64, the 3D printer 12 extrudes filament 49 to fill the cavity 16 to form anchor 40. The high temperature printer head 18 and the high flow rate allows the filament 49 to flow easily and completely fill the cavity 16 without bubbles. The base 14 may also be heated by the controller 26 to help the filament 49 flow into all portions of the cavity 16, including under the flange 38, to form a solid anchor 40.

At block 66, upon completely filling the cavity 16 and forming anchor 40, the 3D printer 12 continues to extrude filament 49 at a lower without interruption to form 3D item 50. The 3D item is allowed to cool and solidify. The anchor 40 is integrated with base 14 and cannot be removed therefrom.

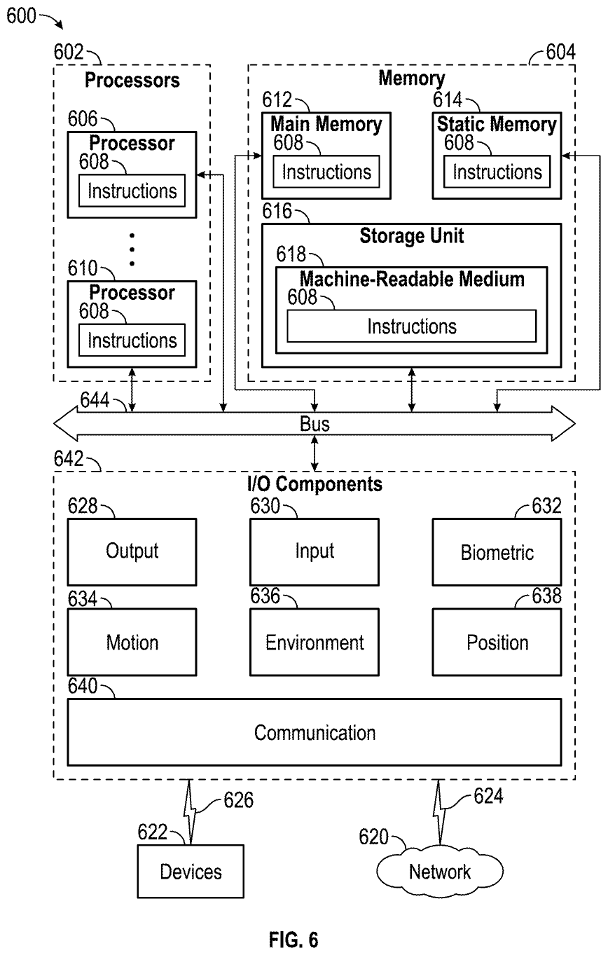

FIG. 6 is a diagrammatic representation of a machine 600 within which instructions 608 (e.g., software, a program, an application, an applet, an app, or other executable code) for causing the machine 600 to perform any one or more of the methodologies discussed herein may be executed. For example, the instructions 608 may cause the machine 600 to execute any one or more of the methods described herein. The instructions 608 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment.

The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines that individually or jointly execute the instructions 608 to perform any one or more of the methodologies discussed herein.

The machine 600 may include processors 602, memory 604, and I/O components 642, which may be configured to communicate with each other via a bus 644. In an example, the processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 606 and a processor 610 that execute the instructions 608. The term “processor” is intended to include multi-core processors that may comprise two or more independent processors (sometimes referred to as “cores”) that may execute instructions contemporaneously. Although FIG. 6 shows multiple processors 602, the machine 600 may include a single processor with a single core, a single processor with multiple cores (e.g., a multi-core processor), multiple processors with a single core, multiple processors with multiples cores, or any combination thereof.

The memory 604 includes a main memory 612, a static memory 614, and a storage unit 616, both accessible to the processors 602 via the bus 644. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 (e.g., a non-transitory machine-readable storage medium) within the storage unit 616, within at least one of the processors 602 (e.g., within the processor's cache memory), or any suitable combination thereof, during execution thereof by the machine 600.

Furthermore, the machine-readable medium 618 is non-transitory (in other words, not having any transitory signals) in that it does not embody a propagating signal. However, labeling the machine-readable medium 618 “non-transitory” should not be construed to mean that the medium is incapable of movement; the medium should be considered as being transportable from one physical location to another. Additionally, since the machine-readable medium 618 is tangible, the medium may be a machine-readable device.

The I/O components 642 may include a wide variety of components to receive input, provide output, produce output, transmit information, exchange information, capture measurements, and so on. The specific I/O components 642 that are included in a particular machine will depend on the type of machine. For example, portable machines such as mobile phones may include a touch input device or other such input mechanisms, while a headless server machine will likely not include such a touch input device. It will be appreciated that the I/O components 642 may include many other components that are not shown in FIG. 6. In various examples, the I/O components 642 may include output components 628 and input components 630. The output components 628 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 630 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location, force of touches or touch gestures, or other tactile input components), audio input components (e.g., a microphone), and the like.

In further examples, the I/O components 642 may include biometric components 632, motion components 634, environmental components 636, or position components 638, among a wide array of other components. For example, the biometric components 632 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 634 include acceleration sensor components (e.g., accelerometer), gravitation sensor components, rotation sensor components (e.g., gyroscope), and so forth. The environmental components 636 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 638 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 642 further include communication components 640 operable to couple the machine 600 to a network 620 or devices 622 via a coupling 624 and a coupling 626, respectively. For example, the communication components 640 may include a network interface component or another suitable device to interface with the network 620. In further examples, the communication components 640 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 622 may be another machine or any of a wide variety of peripheral devices (e.g., a peripheral device coupled via a USB).

Moreover, the communication components 640 may detect identifiers or include components operable to detect identifiers. For example, the communication components 640 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as location via Internet Protocol (IP) geolocation, location via Wi-Fi® signal triangulation, location via detecting an NFC beacon signal that may indicate a particular location, and so forth.

The various memories (e.g., memory 604, main memory 612, static memory 614, memory of the processors 602), storage unit 616 may store one or more sets of instructions and data structures (e.g., software) embodying or used by any one or more of the methodologies or functions described herein. These instructions (e.g., the instructions 608), when executed by processors 602, cause various operations to implement the disclosed examples.

The instructions 608 may be transmitted or received over the network 620, using a transmission medium, via a network interface device (e.g., a network interface component included in the communication components 640) and using any one of a number of well-known transfer protocols (e.g., hypertext transfer protocol (HTTP)). Similarly, the instructions 608 may be transmitted or received using a transmission medium via the coupling 626 (e.g., a peer-to-peer coupling) to the devices 622.

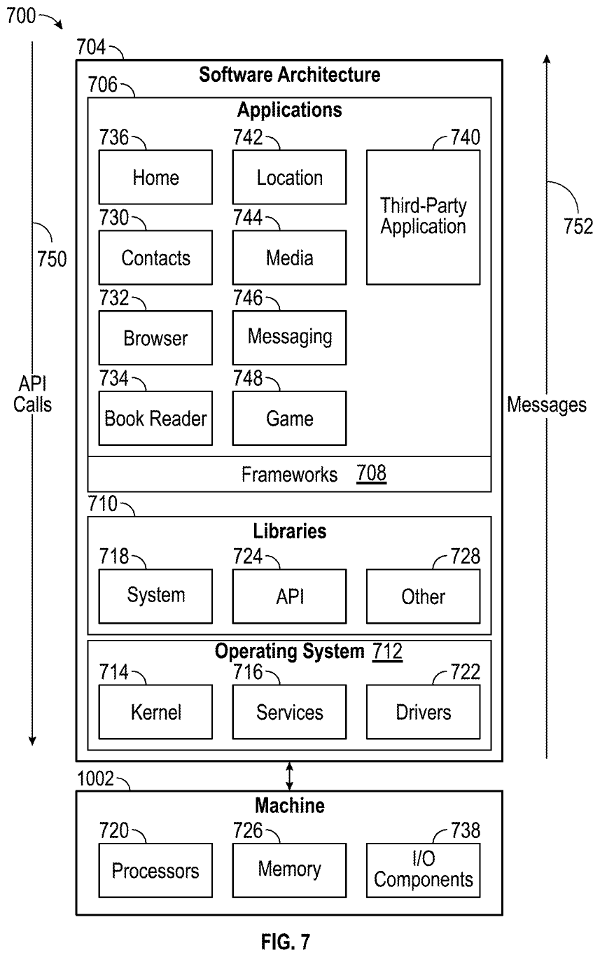

FIG. 7 is a block diagram 700 illustrating a software architecture 704, which can be installed on any one or more of the devices described herein. The software architecture 704 is supported by hardware such as a machine 702 that includes processors 720, memory 726, and I/O components 738. In this example, the software architecture 704 can be conceptualized as a stack of layers, where each layer provides a particular functionality. The software architecture 704 includes layers such as an operating system 712, libraries 710, frameworks 708, and applications 706. Operationally, the applications 706 invoke API calls 750 through the software stack and receive messages 752 in response to the API calls 750.

The operating system 712 manages hardware resources and provides common services. The operating system 712 includes, for example, a kernel 714, services 716, and drivers 722. The kernel 714 acts as an abstraction layer between the hardware and the other software layers. For example, the kernel 714 provides memory management, processor management (e.g., scheduling), component management, networking, and security settings, among other functionality. The services 716 can provide other common services for the other software layers. The drivers 722 are responsible for controlling or interfacing with the underlying hardware. For instance, the drivers 722 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 710 provide a low-level common infrastructure used by the applications 706. The libraries 710 can include system libraries 718 (e.g., C standard library) that provide functions such as memory allocation functions, string manipulation functions, mathematic functions, and the like. In addition, the libraries 710 can include API libraries 724 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 710 can also include a wide variety of other libraries 728 to provide many other APIs to the applications 706.

The frameworks 708 provide a high-level common infrastructure that is used by the applications 706. For example, the frameworks 708 provide various graphical user interface (GUI) functions, high-level resource management, and high-level location services. The frameworks 708 can provide a broad spectrum of other APIs that can be used by the applications 706, some of which may be specific to a particular operating system or platform.

In an example, the applications 706 may include a home application 736, a contacts application 730, a browser application 732, a book reader application 734, a location application 742, a media application 744, a messaging application 746, a game application 748, and a broad assortment of other applications such as a third-party application 740. The applications 706 are programs that execute functions defined in the programs. Various programming languages can be employed to create one or more of the applications 706, structured in a variety of manners, such as object-oriented programming languages (e.g., Objective-C, Java, or C++) or procedural programming languages (e.g., C or assembly language). In a specific example, the third-party application 740 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 740 can invoke the API calls 750 provided by the operating system 712 to facilitate functionality described herein.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

What is claimed is:

1. A method of three-dimensional (3D) printing, comprising:
controlling a 3D printer having a printer head, including establishing a temperature of the printer head and a flow rate of a filament extruded from the printer head;
extruding the filament into a cavity of a base to form an anchor; and
extruding the filament to form a 3D item upon the anchor.

2. The method as specified in claim 1, wherein the filament is continuously extruded by the printer head to form the anchor and the 3D item upon the anchor.

3. The method as specified in claim 1, wherein the temperature of the printer head is higher when forming the anchor than when forming the 3D item.

4. The method as specified in claim 3, wherein the flow rate of the extruded filament is higher when forming the anchor than when forming the 3D item.

5. The method as specified in claim 1, wherein the base has an opening communicating with the cavity, wherein the opening has a smaller diameter than a diameter of the cavity.

6. The method as specified in claim 5, wherein the base has a shoulder encompassing the opening and forming a flange.

7. The method as specified in claim 6, wherein the flange encapsulates the extruded filament in the cavity forming the anchor to retain the anchor such that the 3D item cannot be removed from base.

8. A device, comprising:
a base;
a cavity formed in the base;
an anchor formed in the cavity;
a three-dimensional (3D) item formed on the anchor; and
wherein the 3D item is formed by extruding a filament from a 3D printer into the cavity to form the anchor, and then forming the 3D item upon the anchor.

9. The device as specified in claim 8, wherein the anchor and the 3D item are formed by continuously extruding the filament from a printer head to form the anchor and the 3D item upon the anchor.

10. The device as specified in claim 8, wherein the anchor and the 3D item are formed by controlling a temperature of a printer head to be higher when forming the anchor than when forming the 3D item.

11. The device as specified in claim 10, wherein flow rate of the extruded filament is higher when forming the anchor than when forming the 3D item.

12. The device as specified in claim 8 wherein the base has an opening communicating with the cavity, wherein the opening has a smaller diameter than a diameter of the cavity.

13. The device as specified in claim 12, wherein the base has a shoulder encompassing the opening and forming a flange.

14. The device as specified in claim 13, wherein the flange encapsulates the extruded filament in the cavity forming the anchor to retain the anchor such that the 3D item cannot be removed from base.

15. A non-transitory computer-readable medium storing program code which, when executed, is operative to cause a computing device of a three-dimensional (3D) printer having a printer head to perform the steps of:
controlling the printer head, including establishing a temperature of the printer head and a flow rate of a filament extruded from the printer head;
extruding the filament into a cavity of a base to form an anchor; and
extruding the filament to form a 3D item upon the anchor.

16. The non-transitory computer-readable medium as specified in claim 15, wherein the program code, when executed, is operative to cause the filament to be continuously extruded by the printer head to form the anchor in the base and the 3D item upon the anchor.

17. The non-transitory computer-readable medium as specified in claim 15, wherein the program code, when executed, is operative the cause the temperature of the printer head to be higher when forming the anchor than when forming the 3D item.

18. The non-transitory computer-readable medium as specified in claim 15, wherein the program code, when executed, is operative the cause the flow rate of the extruded filament to be higher when forming the anchor than when forming the 3D item.

19. The non-transitory computer-readable medium as specified in claim 18, wherein the base has an opening communicating with the cavity, wherein the opening has a smaller diameter than a diameter of the cavity.

20. The non-transitory computer-readable medium as specified in claim 18, wherein the base has a shoulder encompassing an opening and forming a flange, wherein the flange encapsulates the extruded filament in the cavity forming the anchor to retain the anchor such that the 3D item cannot be removed from base.
